(19) United States
(12) Patent Application Publication
(10) Pub. No.: US 2022/0289930 A1
(43) Pub. Date: Sep. 15, 2022

(54) THERMAL DECOMPOSITION TREATMENT APPARATUS AND THERMAL DECOMPOSITION TREATMENT METHOD

(71) Applicant: HONDA MOTOR CO., LTD., Tokyo (JP)

(72) Inventors: Masaki Namaizawa, Wako-shi (JP); Tadahiro Shiba, Wako-shi (JP); Kazuhiro Miura, Wako-shi (JP); Syouji Inose, Wako-shi (JP)

(73) Assignee: HONDA MOTOR CO., LTD., Tokyo (JP)

(21) Appl. No.: 17/679,353

(22) Filed: Feb. 24, 2022

(30) Foreign Application Priority Data
Mar. 11, 2021 (JP) 2021-039464

(51) Int. Cl. C08J 11/12; B29B 17/00

(52) U.S. Cl. CPC C08J 11/12; B29B 17/00

(57) ABSTRACT

There is provided with a thermal decomposition treatment apparatus capable of ensuring a sufficient residence time of a resin. The thermal decomposition treatment apparatus for thermally decomposing a resin, comprises: a barrel into which the resin is introduced; and a moving unit configured to move the resin from an introduction port side for the resin to a discharge port side for a thermally decomposed product of the resin in the barrel, wherein the thermal decomposition treatment apparatus includes an enlarged portion having an enlarged cross-sectional area on the discharge port side of the barrel.

### CROSS-REFERENCE TO RELATED APPLICATION

This application claims priority to and the benefit of Japanese Patent Application No. 2021-039464 filed on Mar. 11, 2021, the entire disclosure of which is incorporated herein by reference.

### BACKGROUND OF THE INVENTION

### Field of the Invention

The present invention relates to a thermal decomposition treatment apparatus and a thermal decomposition treatment method.

### Description of the Related Art

In the fields of automobiles, ships, railway vehicles, office equipment, electronic equipment, buildings, and the like, many products or parts are manufactured using resin. On the other hand, from the viewpoint of reuse of resources, products no longer required are collected and effectively used (recycled) as raw materials and energy. The resins in the collected products are thermally decomposed and collected as a monomer, oil, or the like. Japanese Patent No. 3410343 discloses a technique by which an acrylic resin scrap material is heated by a twin-screw extruder having a sealed barrel and collected as a liquid monomer.

### SUMMARY OF THE INVENTION

According to one embodiment of the present invention, a thermal decomposition treatment apparatus for thermally decomposing a resin, comprises: a barrel into which the resin is introduced; and a moving unit configured to move the resin from an introduction port side for the resin to a discharge port side for a thermally decomposed product of the resin in the barrel, wherein the thermal decomposition treatment apparatus includes an enlarged portion having an enlarged cross-sectional area on the discharge port side of the barrel.

According to another embodiment of the present invention, a method for thermally decomposing a resin, comprises: introducing the resin into a treatment space for treating the resin; moving the resin in a first space of the treatment space; and moving the resin in a second space of the treatment space having a larger cross-sectional area than the first space.

### BRIEF DESCRIPTION OF THE DRAWINGS

FIG. 1 is a schematic diagram of a thermal decomposition treatment apparatus according to an embodiment; and

FIG. 2 is a schematic view of a thermal decomposition treatment apparatus according to another embodiment.

### DESCRIPTION OF THE EMBODIMENTS

In the thermal decomposition treatment, the resin is supplied to the barrel and treated. However, in order to thermally decompose the resin in an appropriate manner, it is necessary to allow the resin to sufficiently stay in the barrel. The resin supply amount can be increased by upsizing the barrel to sufficiently secure the residence time of the resin in the barrel. However, there is demand for miniaturization of thermal decomposition treatment apparatuses.

An embodiment of the present invention provides a thermal decomposition treatment apparatus capable of ensuring a sufficient residence time of a resin.

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Thermal Decomposition Treatment Apparatus According to One Embodiment

A thermal decomposition treatment apparatus according to an embodiment includes: a barrel into which a resin is introduced; and a moving unit configured to move the resin from an introduction port side for the resin to a discharge port side for a thermally decomposed product of the resin in the barrel. The thermal decomposition treatment apparatus includes an enlarged portion having an enlarged cross-sectional area on the discharge port side of the barrel, so that the thermal decomposition treatment apparatus is small in size and can secure a sufficient residence time of the resin.

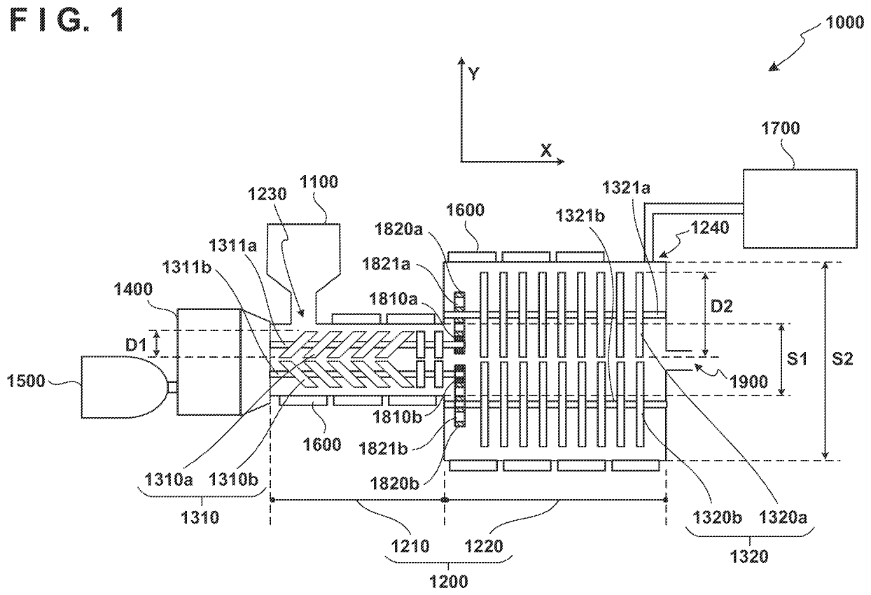

FIG. 1 is a schematic view of a thermal decomposition treatment apparatus according to an embodiment. The thermal decomposition treatment apparatus 1000 according to the embodiment thermally decomposes a resin scrap material or the like by a thermal decomposition treatment unit to collect a thermally decomposed product such as a monomer, and can continuously perform a thermal decomposition treatment of a resin in a large amount. The resin scrap material is a resin collected from various products or parts no longer required, and can contain impurities such as organic substances such as a resin different from the main component resin, and inorganic substances such as metal or glass. The thermal decomposition treatment apparatus 1000 according to the embodiment includes a resin introduction unit 1100, a barrel 1200, moving units 1310 and 1320, a speed reducer 1400, a motor 1500, a heater 1600, and a collection unit 1700. Hereinafter, respective configurations of the above components will be described.

(Resin Introduction Unit)

The resin introduction unit 1100 introduces a resin scrap material or the like into the upstream side of the barrel 1200. The resin introduction unit 1100 is not particularly limited as long as it can introduce a resin. However, a hopper is exemplified to adjust the introduction amount or the introduction speed of the resin into the barrel 1200. The introduction amount or the introduction speed of the resin may be automatically adjusted by the thermal decomposition treatment apparatus 1000 or may be adjusted by a human operator. A lower portion (downstream side) of the resin introduction unit 1100 is connected to a resin introduction port 1230 for the barrel 1200.

(Barrel)

The barrel 1200 includes the heater 1600 on the outer peripheral surface. The barrel 1200 can heat the resin in a sealed state, that is, can pressurize and heat the resin. The barrel 1200 has a first portion 1210 on the introduction port 1230 side for the resin and a second portion 1220 having an enlarged cross-sectional area on a discharge port 1240 side for thermally decomposed product of the resin. The second portion 1220 may be referred to as an enlarged portion.

The shape of the first portion 1210 and the second portion 1220 is not particularly limited as long as they are configured to have an internal volume capable of thermally decomposing the resin, and a cylindrical shape is exemplified. The dimension of the first portion 1210 and the second portion 1220 in a transverse axis direction (Y direction) may be constant or different along a longitudinal axis direction (X direction).

The inside of the barrel 1200 is a treatment space for thermally decomposing the resin, and the treatment space has a first space corresponding to the first portion 1210 and a second space corresponding to the second portion 1220. The volume of the second space may be greater than the volume of the first space. The upstream side of the barrel 1200 is a molten resin zone, the downstream side of the same is a thermal decomposition zone. The first portion 1210 generally corresponds to the molten resin zone, and the second portion 1220 generally corresponds to the thermal decomposition zone.

In the barrel 1200 according to the embodiment, a cross-sectional area S2 of cross section of the enlarged portion 1220 is made larger than a cross-sectional area S1 of cross section of the first portion 1210, in the Y direction that is a direction substantially orthogonal to the X direction (the longitudinal axis direction of the barrel 1200) that is the direction from the introduction port 1230 side for the resin to the discharge port 1240 side for thermally decomposed product of the resin. The cross-sectional area of the cross section of the first portion 1210 in the Y direction is the cross-sectional area of the cross section of the first portion 1210 at or near the end away from the introduction port 1230 for the resin, and the cross-sectional area of the cross section of the enlarged portion 1220 in the Y direction is the cross-sectional area of the cross section of the enlarged portion 1220 at or near the end away from the discharge port 1240 for a thermally decomposed product of the resin. In FIG. 1, the cross-sectional area of the second portion is illustrated to be sharply enlarged from the cross-sectional area of the first portion 1210, but the cross-sectional area of the second portion may be gradually enlarged, intermittently enlarged, or continuously enlarged.

As above, since the barrel 1200 has the enlarged portion 1220, the moving speed of the resin in the barrel 1200 decreases in the enlarged portion 1220 so that a sufficient residence time of the resin in the barrel 1200 can be secured in the thermal decomposition treatment of the resin. In other words, the moving speed of the resin in the thermal decomposition zone decreases as compared with the molten resin zone so that a sufficient time can be secured for the thermal decomposition treatment of the resin in the barrel 1200. Furthermore, since the barrel 1200 has the enlarged portion 1220, the overall length (X direction) of the thermal decomposition treatment apparatus 1000 can be shortened or downsized, so that the degree of freedom of the installation location of the thermal decomposition treatment apparatus 1000 becomes high. The cross-sectional area S1 of the first portion 1210 is small so that heat loss is small and energy saving is achieved.

The ratio of the cross-sectional area S2 of the enlarged portion 1220 to the cross-sectional area S1 of the first portion 1210 is determined without particular limitation by thermal decomposition treatment conditions or the like in melting and decomposition of the resin. However, the ratio can be 1.4 times or more in one embodiment, 2.0 times or more in another embodiment, and 4.0 times or more in still another embodiment. The ratio of the cross-sectional area of the enlarged portion 1220 to the cross-sectional area of the first portion 1210 can be 10.0 times or less in one embodiment, 5.0 times or less in another embodiment. As a result, an appropriate thermal decomposition treatment of the resin is performed.

The ratio of the length of the enlarged portion 1220 to the length of the first portion 1210 is determined without particular limitation by thermal decomposition treatment conditions or the like in melting and decomposition of the resin. However, the ratio can be 0.5 times or more in one embodiment, 0.8 times or more in another embodiment, and 1.0 times or more in still another embodiment. The ratio of the length of the enlarged portion 1220 to the length of the first portion 1210 can be 2.0 times or less in one embodiment, 1.5 times or less in another embodiment, and 1.2 times or less in still another embodiment. As a result, an appropriate thermal decomposition treatment of the resin is performed.

(Moving Unit)

The resin moving units 1310 and 1320 are provided inside the barrel 1200. There are a thermally decomposed resin and a thermally decomposed product of the resin inside the barrel 1200, and they are moved by the moving units 1310 and 1320. Hereinafter, they will be referred to as resin moving units 1310 and 1320. The moving units 1310 and 1320 are not particularly limited as long as they can move the resin in the barrel 1200. Screws capable of crushing and mixing are exemplified.

The moving units 1310 and 1320 include first moving units 1310a and 1310b provided in the first portion 1210 and second moving units 1320a and 1320b provided in the second portion 1220. In the thermal decomposition treatment apparatus 1000 according to the embodiment illustrated in FIG. 1, the first moving units and the second moving units are each constituted by the plurality of moving units 1310a, 1310b, 1320a, and 1320b, but may be each constituted by single moving unit.

As a drive mechanism, a speed reducer 1400 and a motor 1500 are connected to first ends of shafts of the first moving units 1310a and 1310b, and the first moving units 1310a and 1310b are configured to rotate. The second ends of the shafts of the first moving units 1310a and 1310b are interlocked and connected to first ends of shafts of the second moving units 1320a and 1320b via a power transmission unit 1800. The power transmission unit 1800 is not particularly limited as long as it can interlock and connect the first moving units 1310a, 1310b and the second moving units 1320a, 1320b, and examples of the power transmission unit 1800 include a gear, a belt, and the like.

In one embodiment, the power transmission unit 1800 includes first gears 1810a and 1810b provided at second ends of shafts (rotation shafts) 1311a and 1311b of the first moving units 1310a and 1310b, and second gears 1820a and 1820b provided at first ends of shafts (rotation shafts) 1321a and 1321b of the second moving units 1320a and 1320b. The first gears 1810a and 1810b are configured to mesh with the second gears 1820a and 1820b. As a result, applying power from the motor 1500 to the first moving units 1310a and 1310b makes it possible to rotate the second moving units 1320a and 1320b, thereby downsizing the thermal decomposition treatment apparatus 1000. Furthermore, the thermal decomposition treatment apparatus 1000 according to the embodiment can include one drive mechanism such as a motor, which contributes to cost reduction.

The shafts 1321a and 1321b of the second moving units are arranged to be shifted in the Y direction from the shafts 1311a and 1311b of the first moving units, that is, are arranged non-coaxially. This enhances the effect of mixing the resin by the first moving units and the second moving units.

One or more through holes penetrating in the rotation axis direction may be formed around the rotation axes of the first gears 1810a and 1810b, the second gears 1820a and 1820b, or both the gears. In the thermal decomposition treatment apparatus 1000 according to the embodiment, through holes 1821a and 1821b are formed in the second gears 1820a and 1820b. Alternatively, through holes may be formed in the first gears 1810a and 1810b. This reduces the weights of the first gears 1810a and 1810b and the second gears 1820a and 1820b, and decreases the amounts of materials used for the gears. Furthermore, the through holes serve as a flow path of the resin, thereby increasing the moving speed of the resin.

An outer diameter D2 of the second moving units 1320a and 1320b is larger than an outer diameter D1 of the first moving units 1310a and 1310b. This makes it possible to efficiently stir the resin according to the cross-sectional areas of the first portion 1210 and the enlarged portion 1220, keep the temperature in the thermal decomposition treatment uniform, and suppress a carbide from adhering to the inside of the barrel 1200. Furthermore, since the resin is moved at a relatively low moving speed in the enlarged portion 1220, the induction resistance at the screw ends can be reduced. In addition, making the outer diameter D1 small relative to the outer diameter D2 suppresses the speed difference between the first portion 1210 and the enlarged portion 1220 from becoming excessively large and reduces the flow resistance generated in the cross-sectional direction due to the speed difference, thereby realizing energy-saving operation.

(Collection Unit)

The collection unit 1700 is configured to collect a thermally decomposed product (monomer or the like) thermally decomposed in the barrel 1200. The collection unit 1700 includes a storage unit, a condenser, a collection tank, and a pump. The storage unit stores the thermally decomposed product, and the decomposed gas in the stored thermally decomposed product is transferred to a condenser, where it condenses to a liquid, thermally decomposed product. The liquid, thermally decomposed product is collected in the collection tank connected to the condenser. A pump for discharging the remained gas is connected to the collection tank. On the other hand, the thermally decomposed product also contains a residue and the like, and the residue is taken out by a residue storage unit through an extraction port 1900 and stored in the residue storage unit. The residue storage unit may be connected to the storage unit of the collection unit 1700.

### Thermal Decomposition Treatment Apparatus According to Another Embodiment

In a thermal decomposition treatment apparatus according to another embodiment, a first moving unit and a second moving unit are individually provided with drive mechanisms, so that the moving speeds of the resin in the first moving unit and the second moving unit, the torques of the first moving unit and the second moving unit, and the like can be adjusted individually. In the thermal decomposition treatment apparatus according to the other embodiment, the second moving unit in the thermal decomposition treatment apparatus 1000 according to the above embodiment includes a drive mechanism. Hereinafter, differences from the thermal decomposition treatment apparatus 1000 according to the above embodiment will be mainly described. The identical components are denoted by identical reference numerals.

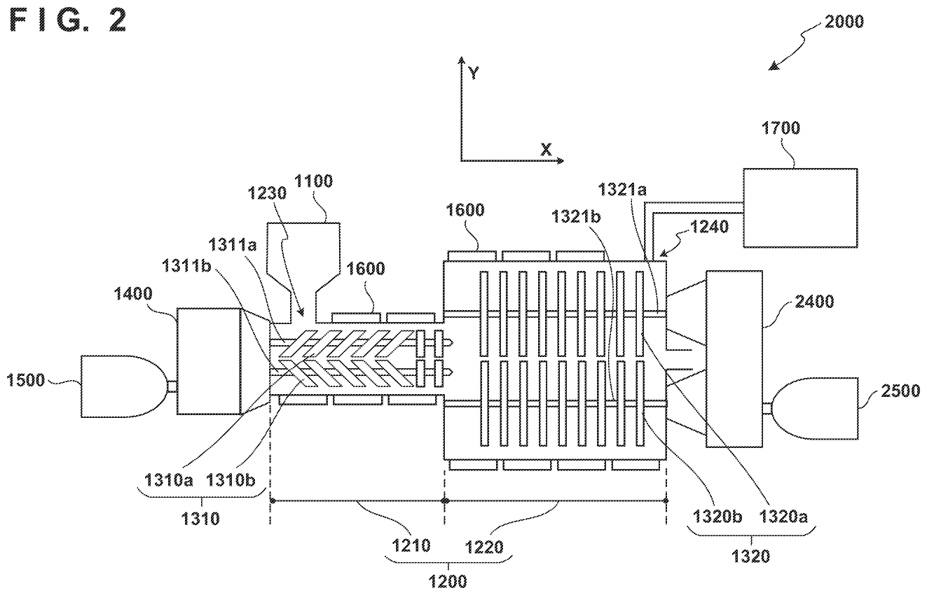

FIG. 2 is a schematic view of the thermal decomposition treatment apparatus according to the other embodiment. The thermal decomposition treatment apparatus 2000 includes a resin introduction unit 1100, a barrel 1200, moving units 1310 and 1320, speed reducers 1400, 2400, motors 1500, 2500, a heater 1600, and a collection unit 1700. In the thermal decomposition treatment apparatus according to the other embodiment, first moving units 1310a and 1310b are connected to the speed reducer 1400 and the motor 1500 which constitute a drive mechanism, and second moving units 1320a and 1320b are connected to the speed reducer 2400 and the motor 2500 which constitute a drive mechanism.

This makes it possible to, during the operation of the thermal decomposition treatment apparatus 2000, monitor the loads (torques) on the motors 1500 and 2500 in the first moving units 1310a and 1310b and the second moving units 1320a and 1320b, and increase or decrease the outputs (kW) of the motors 1500 and 2500 in accordance with the load changes, thereby adjusting the moving speed of the resin.

In addition, the thermal decomposition treatment apparatus 2000 according to another embodiment can suppress a speed difference between the first portion 1210 and the enlarged portion 1220 from becoming excessively large, can decrease the flow resistance generated in the cross-sectional direction due to the speed difference, and can reduce the amount of energy used due to the reduction in the moving speed (rotation speed). In addition, the enlarged portion 1220 generally corresponds to a thermal decomposition zone, and the thermally decomposed product is discharged from the discharge port 1240 or the like, so that a relatively small driving force may be used in the enlarged portion 1220 and a moving speed (rotation speed) may be lowered, thereby achieving energy consumption reduction.

Since the second moving units 1320a and 1320b are connected to the drive mechanism, the first moving units 1310a and 1310b and the second moving units 1320a and 1320b may not be connected together via power transmission units or the like.

### Thermal Decomposition Treatment Method According to One Embodiment

A thermal decomposition treatment method according to an embodiment includes: introducing a resin into a treatment space in which the resin is to be treated; moving the resin in a first space of the treatment space; and moving the resin in a second space of the treatment space having a cross-sectional area larger than that of the first space, thereby securing a sufficient residence time of the resin.

(Resin)

The resin (resin scrap material) to be thermally decomposed is not particularly limited as long as a thermally decomposed product (monomer or the like) is collected from the resin by thermal decomposition treatment, and examples thereof include an acrylic resin, an olefin resin (polyethylene, polypropylene, etc.), polyamide, polyvinyl chloride, a polyester resin (polyethylene terephthalate, polycarbonate, etc.), polytetrafluoroethylene, polyacetal, polybutadiene, polyisoprene, and a polystyrene resin.

(Resin Introduction Step)

The resin is introduced into the barrel 1200 (treatment space) for thermally decomposing the resin via the resin introduction unit 1100. As described above, the treatment space has the first space corresponding to the first portion 1210 and the second space corresponding to the second portion 1220, and the resin is introduced into the first space. The introduction amount of the resin varies depending on the size and performance of the thermal decomposition treatment apparatus 1000 or 2000, but the resin can be introduced at about 0.5 to 20,000 kg/hr. The introduction amount of the resin can be adjusted by the rotation speed of the moving units 1310 and 1320, and the rotation speed is 100 to 2000 rpm, for example. The resin may be automatically introduced by the thermal decomposition treatment apparatus 1000 or 2000 or may be introduced by a human operator.

(First Moving Step)

The resin introduced into the first space (first portion 1210) is moved from the introduction port 1230 side for the resin to the discharge port 1240 side for a thermally decomposed product of the resin by the first moving units 1310a and 1310b while being heated by the heater 1600, and is introduced into the second space (second portion 1220).

(Second Moving Step)

The resin introduced into the second space (second portion 1220) is moved to the resin thermally decomposed product discharge port 1240 side by the second moving units 1320a and 1320b while being heated by the heater 1600. The second space is a space having a larger cross-sectional area than the first space, and the resin is moved in the second space at a moving speed lower than a moving speed of the resin in the first space. This makes it possible to, in the resin thermal decomposition treatment, secure a sufficient residence time in the second treatment space.

(Thermal Decomposition Treatment Step)

The resin is melted in a melting zone (generally the first space) and is thermally decomposed in a thermal decomposition zone (generally the second space) downstream o the melting zone to form a thermally decomposed product. The temperature of the barrel 1200 is set to, for example, 300 to 600° C. The residence time of the resin in the barrel 1200 varies depending on the introduction amount of the resin or the like, and is, for example, 1 to 180 minutes.

(Collection Step)

The thermally decomposed product generated by the thermal decomposition treatment unit 1000 or 2000 is stored in the collection unit 1700. In the collection unit 1700, the decomposed gas of the thermally decomposed product is transferred to the condenser, condensed by the condenser into a liquid, thermally decomposed product, and collected in the collection tank.

### Summary of Embodiments

The above embodiments disclose at least the following thermal decomposition treatment apparatus and thermal decomposition treatment method.

1. The thermal decomposition treatment apparatus (1000 or 2000) according to the above embodiments includes:

a barrel (1200) into which a resin is introduced; and

a moving unit (1310, 1320) configured to move the resin from an introduction port (1230) side for the resin to a discharge port (1240) side for a thermally decomposed product of the resin in the barrel (1200), and the thermal decomposition treatment apparatus includes an enlarged portion (1220) having an enlarged cross-sectional area on the discharge port (1240) side of the barrel (1200).

According to the embodiments, it is possible to secure a small size and a sufficient residence time of the resin. Furthermore, since not the entire barrel but a part thereof has the enlarged diameter portion, the dimension of the first portion of the barrel is small, thereby reducing the heat loss.

2. In the above embodiments, the moving unit (1310, 1320) includes a first moving unit (1310a, 1310b) on the introduction port side and a second moving unit (1320a, 1320b) on the discharge port side.

According to the embodiments, the resin can be efficiently moved according to the cross-sectional areas of the first portion and the enlarged portion.

3. In the above embodiments, an outer diameter (D2) of the second moving unit (1320a, 1320b) is larger than an outer diameter (D1) of the first moving unit (1310a, 1310b).

According to the embodiments, it is possible to efficiently stir the resin according to the cross-sectional areas of the first portion and the enlarged portion, keep the temperature in the thermal decomposition treatment uniform, and suppress a carbide from adhering to the inside of the barrel. Furthermore, since the resin is moved at a relatively low moving speed in the enlarged portion 1220, the induction resistance at the screw ends can be reduced. In addition, making the outer diameter D1 small relative to the outer diameter D2 suppresses the speed difference between the first portion and the enlarged portion from becoming excessively large and reduces the flow resistance generated in the cross-sectional direction due to the speed difference, thereby realizing energy-saving operation.

4. In the above embodiments, an axis (1321a, 1321b) of the second moving unit (1320a, 1320b) is shifted from an axis (1311a, 1311b) of the first moving unit (1310a, 1310b).

According to the embodiments, it is possible to enhance the effect of mixing the resin by the first moving unit and the second moving unit.

5. In the thermal decomposition treatment apparatus of the above embodiments, the second moving unit (1320a, 1320b) is interlocked and connected to the first moving unit (1310a, 1310b) via a power transmission unit (1800).

According to the embodiments, applying power from the motor to the first moving unit makes it possible to rotate the second moving unit, thereby downsizing the thermal decomposition treatment apparatus.

6. In the above embodiments, the power transmission unit (1800) includes a gear (1810a, 1810b, 1820a, 1820b), and the gear (1810a, 1810b, 1820a, and 1820b) has a through hole (1821a, 1821b).

According to the embodiments, the gear is reduced in weight, and the material used is decreased. Furthermore, the through holes serve as a flow path of the resin, thereby increasing the moving speed of the resin.

7. In the above embodiments, the first moving unit (1310a, 1310b) and the second moving unit (1320a, 1320b) are each individually provided with a drive mechanism.

According to the embodiment, the moving speeds of the resin in the first moving unit and the second moving unit can be individually adjusted.

8. In the above embodiments, the first moving unit (1310a, 1310b) and the second moving unit (1320a, 1320b) each have a plurality of moving units (1310a, 1310b, 1320a, 1320b).

According to this embodiment, the mixing efficiency of the resin can be improved.

9. In the above embodiments, the moving unit (1310, 1320) is a screw.

According to the embodiments, the thermal decomposition treatment can be performed under optimum conditions.

10. The thermal decomposition treatment method according to the above embodiments is a method for thermally decomposing a resin that includes: introducing the resin into a treatment space for treating the resin; moving the resin in a first space of the treatment space; and moving the resin in a second space of the treatment space having a larger cross-sectional area than the first space.

According to the embodiments, it is possible to secure a small size and a sufficient residence time of the resin.

The invention is not limited to the foregoing embodiments, and various variations/changes are possible within the spirit of the invention.

What is claimed is:

1. A thermal decomposition treatment apparatus for thermally decomposing a resin, comprising:
a barrel into which the resin is introduced; and
a moving unit configured to move the resin from an introduction port side for the resin to a discharge port side for a thermally decomposed product of the resin in the barrel, wherein
the thermal decomposition treatment apparatus includes an enlarged portion having an enlarged cross-sectional area on the discharge port side of the barrel.

2. The thermal decomposition treatment apparatus according to claim 1, wherein the moving unit includes a first moving unit on the introduction port side and a second moving unit on the discharge port side.

3. The thermal decomposition treatment apparatus according to claim 2, wherein an outer diameter of the second moving unit is larger than an outer diameter of the first moving unit.

4. The thermal decomposition treatment apparatus according to claim 2, wherein an axis of the second moving unit is shifted from an axis of the first moving unit.

5. The thermal decomposition treatment apparatus according to claim 2, wherein the second moving unit is interlocked and connected to the first moving unit via a power transmission unit.

6. The thermal decomposition treatment apparatus according to claim 5, wherein the power transmission unit includes a gear, and the gear has a through hole.

7. The thermal decomposition treatment apparatus according to claim 2, wherein the first moving unit and the second moving unit are each individually provided with a drive mechanism.

8. The thermal decomposition treatment apparatus according to claim 2, wherein the first moving unit and the second moving unit each have a plurality of moving units.

9. The thermal decomposition treatment apparatus according to claim 1, wherein the moving unit is a screw.

10. A method for thermally decomposing a resin, comprising:
introducing the resin into a treatment space for treating the resin;
moving the resin in a first space of the treatment space; and
moving the resin in a second space of the treatment space having a larger cross-sectional area than the first space.
